(19) United States
(12) Patent Application Publication
(10) Pub. No.: US 2017/0305661 A1
(43) Pub. Date: Oct. 26, 2017

(54) Grease Disposing Bag/Pouch

(71) Applicants: LaTangela Newsome, Allen, TX (US); Robert Newsome, Pensacola, FL (US); Gwendolyn Newsome, Pensacola, FL (US)

(72) Inventors: LaTangela Newsome, Allen, TX (US); Robert Newsome, Pensacola, FL (US); Gwendolyn Newsome, Pensacola, FL (US)

(21) Appl. No.: 15/133,810

(22) Filed: Apr. 20, 2016

(51) Int. Cl. B65F 1/00; B65D 33/25; B65F 1/14

(52) U.S. Cl. CPC B65F 1/002; B65F 1/1405; B65D 33/2508; B65F 2210/167; B65F 2240/142; B65F 2210/1023

(57) ABSTRACT

A grease disposing bag/pouch to dispose of grease may include a first sheet; a second sheet connected to the first sheet to define a cavity; and a filter insert being removably positioned in the cavity. The first and second sheet may be formed from a plant-based film.

### FIELD OF THE INVENTION

The present invention relates to flexible pouches and more particularly to a flexible pouch which may include a filter sheet/pad to filter grease and other contaminants.

### BACKGROUND

The use of re-closable flexible pouches has seen dramatic increases in the last few years. Heretofore, the primary market for bags with slider zippers has been a consumer who purchases empty slider bags and then fills the slider bags with products at home. However, with the increasing popularity of slider bags most manufacturers now tend to package their food and non-food products in slider bags for sale to consumers. The slider bags are a great convenience to the consumer who purchases these product filled bags especially for products of the type where only a portion of the product is used at any given time.

The disposal of grease and other grease like materials is difficult. Placing the grease in the garbage disposal tends to clog the plumbing and the garbage disposal, resulting in a costly repair. Throwing the grease in the garbage may cause additional problems. The grease may leak from a storage container, requiring a cleanup which may be messy and time-consuming.

### SUMMARY

A grease disposing bag/pouch to dispose of grease may include a first sheet; a second sheet connected to the first sheet to define a cavity; and a filter insert being removably positioned in the cavity.

The first and second sheet may be formed from a plant-based film.

The filter insert may be formed from organic material.

The filter insert may include apertures.

The grease disposing bag/pouch may include a closure device to seal the cavity.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front view of the grease disposing bag/pouch of the present invention;

FIG. 2 illustrates a side view of the grease dispensing bag/pouch of the present invention;

FIG. 3 illustrates another front view of the grease dispensing bag/pouch of the present invention;

FIG. 4 illustrates a perspective view of the grease dispensing bag/pouch of the present invention;

FIG. 5 illustrates a top view of the grease dispensing bag/pouch of the present invention.

### DETAILED DESCRIPTION

The present invention provides a device to dispose of used cooking oils and animal fats in an environmental friendly way. The bag/pouch of the present invention absorbs, encapsulates and converts these oils and fats into earth friendly hydrocarbons that are safe for landfills or even to be used as compost in the garden. The encapsulation and conversion is achieved with a insert sheet which may be organic-based (question to have a name of sample material) which filters the oils and fats With a plant based packaging such as a sugarcane-based bag and near hundred percent organic absorbing materials, grease bags are biodegradable compostable and good for our planet. Simply pour the cooking oil and animal fat into the bag/pouch seal it up and throw it away on the compost pile without a mess and with a clear conscience.

The bags/pouches may have zipper closures and typically consist of two substantially similar sized and opposing sheets of plant-based film (usually supplied from a pair of continuous web spools or rolls) which are then sealed together at a lower end of the sheets to form a front layer and a rear layer, with the seal forming a bottom edge of the bag. Alternatively, the bag/pouch may be formed by a length of bag film folded upon itself to form a front layer and a rear layer connected by an integral bottom edge defined by the fold. Side edges of the plant based bag are typically sealed using a sealing head. The zipper typically has a two opposing walls with pairs of inter locking members on each side. When the two walls of the zipper are brought together the interlocking members lock and provide a seal to the plant based bag.

The slider device may include a separator or plow-type structure in the middle, or at one end, that opens a zipper closure mechanism formed on the front and back layer having male and female interlocking profiled elements or closure profiles when the slider device travels in a first direction along the zipper closure. The sidewalls of the slider device are inwardly tapered from one end to the opposite end so that the sidewalls engage the closure profiles and progressively move them into engagement to close the re-closable package when the slider device is moved along the zipper closure in a direction opposite to the first direction.

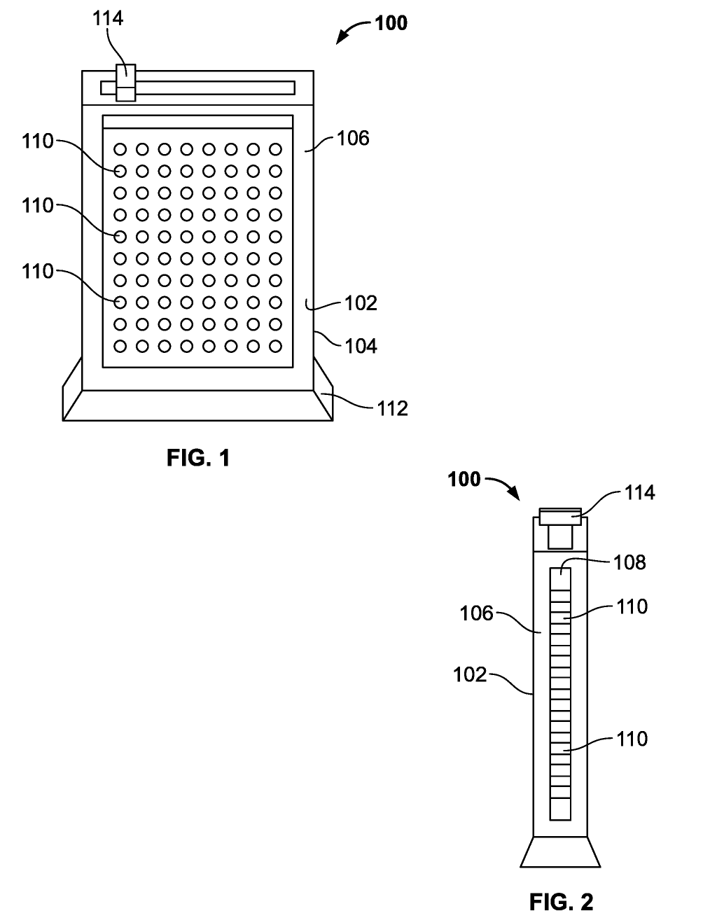

FIG. 1 illustrates a front view of the grease disposing bag/pouch 100 of the present invention, and the grease disposing bag/pouch 100 may include an opposing pair of sheets which may include a first sheet 102 and a second sheet 104 which may be sealed along the bottom and two sides to form a central cavity 106 to house a filter insert 108 which may be removable from the central cavity 106 to absorb the grease and oil. The filter insert 108 may be formed from organic material and may include a plurality of apertures 110 which extend through the filter insert 108 in order to increase the absorption efficiency of the filter insert 108. Optionally, the disposable bags/pouch 100 may include a base 112 which may allow the disposable bag/pouch 100 to stand upright. FIG. 1 shows a substantially rectangular disposable bag/pouch 100 but may be shaped as a cylinder, oval or other appropriate shape. FIG. 1 additionally illustrates a closure device 114 to close and open the top of the disposable bag/pouch 100 as described herein, providing a leak proof seal for the cavity 106.

FIG. 2 illustrates a side view of the grease disposing bag/pouch 100 of the present invention, and the grease disposing bag/pouch 100 may include an opposing pair of sheets which may include a first sheet 102 and a second sheet 104 which may be sealed along the bottom and two sides to form a central cavity 106 to house a filter insert 108 which may be removable from the central cavity 106 to absorb the grease and oil. The filter insert 108 may be formed from organic material and may include a plurality of apertures 110 which extend through the filter insert 108 in order to increase the absorption efficiency of the filter insert 108. Optionally, the disposable bags/pouch 100 may include a base 112 which may allow the disposable bag/pouch 100 to stand upright. FIG. 2 shows a substantially rectangular disposable bag/pouch 100 but may be shaped as a cylinder, oval or other appropriate shape. FIG. 2 additionally illustrates a closure device 114 to close and open the top of the disposable bag/pouch 100, providing a leak proof seal for the cavity 106.

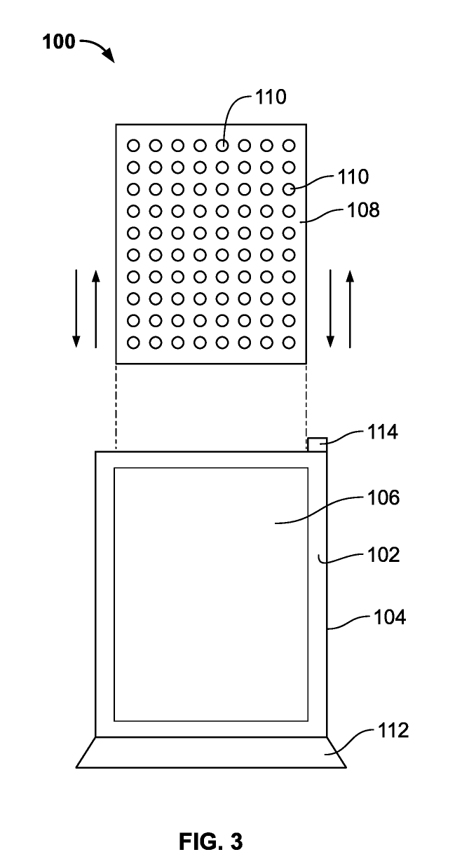

FIG. 3 illustrates a front view of the grease disposing bag/pouch 100 of the present invention, and the grease disposing bag/pouch 100 may include an opposing pair of sheets which may include a first sheet 102 and a second sheet 104 which may be sealed along the bottom and two sides to form a central cavity 106 to house a filter insert 108 which may be removable from the central cavity 106 to absorb the grease and oil. FIG. 3 illustrates that the filter insert 108 has been removed from the central cavity 106, and a new filter insert 108 may be added to the grease disposing bag/pouch 100. The filter insert 108 may be formed from organic material and may include a plurality of apertures 110 which extend through the filter insert 108 in order to increase the absorption efficiency of the filter insert 108. Optionally, the disposable bags/pouch 100 may include a base 112 which may allow the disposable bag/pouch 100 to independently stand upright. FIG. 3 shows a substantially rectangular disposable bag/pouch 100 but may be shaped as a cylinder, oval or other appropriate shape. FIG. 3 additionally illustrates a closure device 114 to close and open the top of the disposable bag/pouch 100 allowing access to the cavity 106, providing a leak proof seal for the cavity 106.

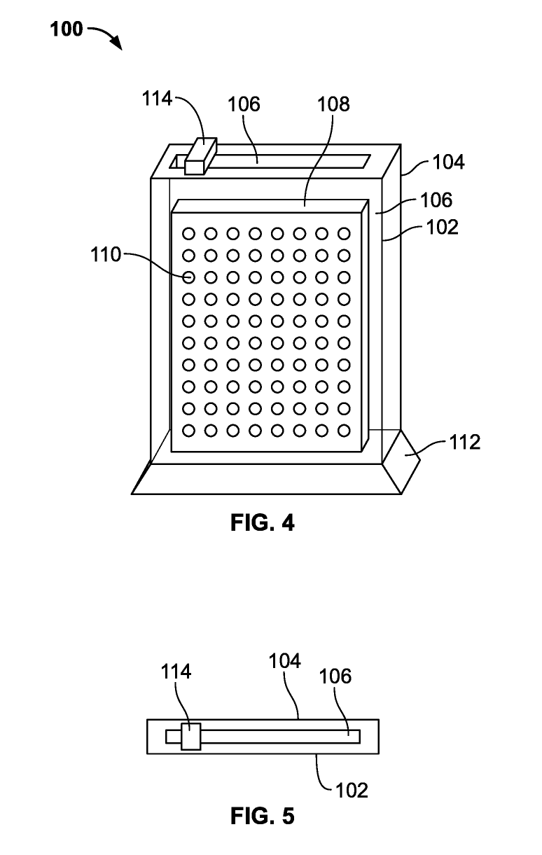

FIG. 4 illustrates a perspective view of the grease disposing bag/pouch 100 of the present invention, and the grease disposing bag/pouch 100 may include an opposing pair of flexible sheets which may include a first sheet 102 and a second sheet 104 which may be sealed along the bottom and two sides to form a central cavity 106 to house a flexible filter insert 108 which may be removable from the central cavity 106 to absorb the grease and oil. The filter insert 108 may be formed from organic material and may include a plurality of apertures 110 which extend through the filter insert 108 in order to increase the absorption efficiency of the filter insert 108. Optionally, the disposable bags/pouch 100 may include a base 112 which may allow the disposable bag/pouch 100 to stand upright. FIG. 4 shows a substantially rectangular disposable bag/pouch 100 but may be shaped as a cylinder, oval or other appropriate shape. FIG. 4 additionally illustrates a closure device 114 to close and open the top of the disposable bag/pouch 100, providing a leak proof seal for the cavity 106.

FIG. 5 illustrates a top view of the grease disposing bag/pouch 100 and illustrates the closure device 114 to close and seal the first sheet 102 and the second sheet 104 and to seal the cavity 106.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A grease disposing bag/pouch to dispose of grease, comprising;
a first sheet;
a second sheet connected to the first sheet to define a cavity;
a filter insert being removably positioned in the cavity;
wherein the first and second sheet is formed from a plant-based film.

2) A grease disposing bag/pouch to dispose of grease as in claim 1, wherein the filter insert is formed from organic material.

3) A grease disposing bag/pouch to dispose of grease as in claim 1, wherein the filter insert includes apertures.

4) A grease disposing bag/pouch to dispose of grease as in claim 1, wherein the grease disposing bag/pouch includes a closure device to seal the cavity.
